(19) United States
(12) Patent Application Publication
(10) Pub. No.: US 2026/0268595 A1
(43) Pub. Date: Sep. 10, 2026

(54) PERSONALIZED AVATAR ADJUSTMENT USING TEXT PROMPTED IMAGE GENERATION

(71) Applicant: Meta Platforms Technologies, LLC, Menlo Park, CA (US)

(72) Inventors: Zohar Barzelay, Haifa (IL); Rotem Bennet, Ein Carmel (IL); Maxim Bluvshtein, Herzliya (IL); Oded Krams, Tel Aviv (IL); Liat Sless, Tel Aviv (IL)

(21) Appl. No.: 19/074,102

(22) Filed: Mar. 7, 2025

(51) Int. Cl. G06T 17/00; G06T 11/60; G06T 19/00; G06V 40/16

(52) U.S. Cl. CPC G06T 17/00; G06T 11/60; G06T 19/006; G06V 40/168

(57) ABSTRACT

An embodiment includes generating, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature. An embodiment includes adjusting, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images. An embodiment includes generating, using a three-dimensional modelling model, from the set of two-dimensional images comprising the second two-dimensional image, a three-dimensional model corresponding to the set of two-dimensional images.

### TECHNICAL FIELD

The present disclosure generally relates to avatar generation, and more particularly to personalized avatar adjustment using text prompted image generation.

### BACKGROUND

A social media platform refers to a website or software application that allows users to share content with each other. Users of a social media platform typically generate content to share, such as still images, audio, or video (often including audio), on a mobile device, because mobile devices typically include a suitable camera, a microphone, a connection to a communications network such as the internet, and can execute a software application that uploads content to the social media platform.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Mixed reality” or “MR,” as used herein, refers to any of VR, AR, XR, or any combination or hybrid thereof.

In computing, an avatar is a graphical representation of a user, a user's persona (e.g., teacher or student), or a user's character (e.g., in a game). With appropriate platform support, an avatar can be a two-dimensional or three-dimensional representation. Three-dimensional representations are popular for use in MR environments. As well, a three-dimensional model can be rendered in two dimensions from a variety of viewpoints. One typically used method generates a three-dimensional representation of a user from a set of two-dimensional images, for example of the user's face in individual poses or a video clip of the user's face, then renders the resulting avatar in two or three dimensions as appropriate.

### SUMMARY

Some embodiments of the present disclosure provide a computer-implemented method for personalized avatar adjustment using text prompted image generation. The method includes generating, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature; adjusting, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and generating, using a three-dimensional modelling model, from the set of two-dimensional images comprising the second two-dimensional image, a three-dimensional model corresponding to the set of two-dimensional images..

Some embodiments of the present disclosure provide a non-transitory computer-readable medium storing a program for personalized avatar adjustment using text prompted image generation. The program, when executed by a computer, configures the computer to generate, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature; adjust, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and generate, using a three-dimensional modelling model, from the set of two-dimensional images comprising the second two-dimensional image, a three-dimensional model corresponding to the set of two-dimensional images.

Some embodiments of the present disclosure provide a system for personalized avatar adjustment using text prompted image generation. The system comprises a processor and a non-transitory computer readable medium storing a set of instructions, which when executed by the processor, configure the processor to generate, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature; adjust, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and generate, using a three-dimensional modelling model, from the set of two-dimensional images comprising the second two-dimensional image, a three-dimensional model corresponding to the set of two-dimensional images.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement personalized avatar adjustment using text prompted image generation, according to some embodiments.

FIG. 2 is a block diagram illustrating details of a system for personalized avatar adjustment using text prompted image generation, according to some embodiments.

FIG. 3 depicts a block diagram of an example configuration for personalized avatar adjustment using text prompted image generation, in accordance with an illustrative embodiment.

FIG. 4 depicts an example of personalized avatar adjustment using text prompted image generation, in accordance with an illustrative embodiment.

FIG. 5 depicts a continued example of personalized avatar adjustment using text prompted image generation, in accordance with an illustrative embodiment.

FIG. 6 depicts a flowchart of an example process for personalized avatar adjustment using text prompted image generation. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The illustrative embodiments recognize that creating an avatar that accurately represents oneself can be a challenging task, especially when it comes to making updates or improvements. Users often struggle to enhance their avatar's appearance without compromising their identity by unduly distorting the avatar's appearance. Presently available avatar adjustment techniques require artistic expertise or rely on limited and inflexible editing tools, making it difficult for non-professionals to achieve the desired look. Furthermore, attempting to edit the avatar's appearance frame-by-frame in rendered video output leads to inconsistent results due to the inherent randomness of image generation models, resulting in unpredictable and unappealing outcomes. Thus, there is a need for an improved avatar adjustment solution that uses text prompts for a desired enhancement while producing consistent results and preserving aspects of a user's identity.

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

Embodiments of the present disclosure address the above identified problems by implementing personalized avatar adjustment using text prompted image generation. In particular, an embodiment generates, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature; adjusts, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and generates, using a three-dimensional modelling model, from the set of two-dimensional images comprising the second two-dimensional image, a three-dimensional model corresponding to the set of two-dimensional images.

An embodiment receives, as input, a set of two-dimensional (2D) images. Images in the set of 2D images depict a user's face, for adjustment and generation of a three-dimensional (3D) model of the user's face. Two non-limiting examples of a set of 2D images are a series of images of individual poses of the user's face (e.g., with varying facial expressions or head positions) or individual frames of a portion of video. An embodiment also receives, as input, an adjustment instruction. In some embodiments, the adjustment instruction is in text form. The adjustment instruction need not be in structured text form. Some non-limiting examples of an adjustment instruction are “add red lipstick”, “add eyeliner”, “add smoky eyeshadow”, “add light makeup”, “add night-out makeup”, “add business professional makeup”, “remove mole”, “smooth skin”, “lighten hair color one shade”, “darken hair color one shade”, “add some grey at temples”, “retouch grey hair roots”, an instruction to provide makeup inspired by a well-known actor or singer, “simplify this image”, “make this image more realistic”, and the like. In some embodiments, the adjustment instruction is in the form of an image, such as a reference or target image. In some embodiments, the adjustment instruction is a combination of an image and text, for example “make me look like this image”.

An embodiment uses a presently available technique to recognize one or more facial features in a 2D image in the set of 2D images. Some non-limiting examples of a facial feature are lips, nose, eyebrows, eyes and mouth. An embodiment generates a segmentation mask corresponding to the image. The segmentation mask identifies a changeable portion and a non-changeable portion of the image. As modifying the size, shape, and geometrical relationships between areas such as the eyes and mouth can alter presentation of a user's identity too much to be perceived as still portraying the same user, some embodiments include one or more facial features, such as lip, nose, eyebrow, eye, and mouth portions of the 2D image, within one or more non-changeable portions of the segmentation mask. Other areas of a user's face, such as cheeks, forehead, and hair, are typically less important in portraying a user's identity, and thus an embodiment adds these areas to a changeable portion of the segmentation mask. Some embodiments provide a suer an ability to specify (e.g., in a user profile or in an adjustment instruction) which facial features, if any, are designated as non-changeable. In other embodiments, the non-changeable facial features are predetermined.

An embodiment generates a numerical representation of the 2D image and a numerical representation of the image's corresponding segmentation mask. A numerical, optionally compressed, representation of an input image is usable to reconstruct the image. Modifying a numerical representation of an input image modifies the reconstructed image accordingly. One non-limiting example of a numerical representation is a latent vector representing an image within a latent diffusion model. Each numerical representation is in the same size and format. Two non-limiting examples of a numerical representation format are a 64×64 matrix of floating-point numbers (or a matrix rearranged into a one-dimensional vector) for a 512×512 input image and a 64×64 tensor of N values per point (thus, dimensions of 64×64×N). Generating numerical representations preserves spatial meaning of the source images, and thus a numerical representation of the segmentation mask is usable to delineate changeable and non-changeable portions of the numerical representation of the 2D image. Techniques are presently available to generate numerical representations of both the 2D image and the segmentation mask.

An embodiment generates a positive prompt and a negative prompt from an input adjustment instruction. A positive prompt instructs an image modification model to adjust an image towards a goal, and a negative prompt instructs an image modification model to adjust an image away from the same goal or towards an opposite goal. For example, for an adjustment instruction of “add eyeliner”, corresponding positive and negative prompts might be “add eyeliner” and “remove eyeliner” respectively. As another example, for an adjustment instruction of “smooth skin”, corresponding positive and negative prompts might be “smooth skin” and “blemished skin” respectively. If an adjustment instruction includes an image, an embodiment uses a presently available technique to generate a text description of the image and includes the generated text description into a positive prompt, negative prompt, or both. To generate a positive prompt and a negative prompt from an input adjustment instruction, an embodiment uses a presently available technique, such as using a trained natural language processing model, a trained large language model (LLM), or a set of rules or heuristics.

From a numerical representation of the input two-dimensional image, a numerical representation of a segmentation mask corresponding to the input 2D image, a positive prompt, and a negative prompt, an embodiment uses an image modification model to adjust the input two-dimensional image. The adjusting results in a second two-dimensional image. An embodiment replaces the input 2D image with the second two-dimensional image in the set of two-dimensional images. In one embodiment, the image modification model is a pre-trained diffusion model such as a delta denoising score (DDS) optimization model, a presently available technique. The DDS model has been trained to modify a numerical representation of an input image, masked by the numerical representation of the segmentation mask, to be more like the positive prompt than the negative prompt. The image modification model operates on a per-image or per-frame basis, without enforcing consistency among modified images in the set of input 2D images. The amount of image adjustment is controllable by adjusting the model's control parameters, such as the number of optimization iterations the model is to perform or a completion criterion for the model's adjustments. Other image modification models, using either positive and negative prompts or a single adjustment instruction, are also possible and contemplated within the scope of the illustrative embodiments.

One embodiment performs a blending operation on numerical representations of the input two-dimensional image and the adjusted two-dimensional image. If O denotes a set of parameters of the original two-dimensional image and M denotes a corresponding set of parameters of the adjusted, or modified, two-dimensional image, one embodiment computes a blended representation B=alpha*O+(1-alpha)*M, where alpha denotes a constant. Blending allows an embodiment to combine the two images, thus moderating output of the image adjustment model. For example, if the adjustment instruction was to add red lipstick, blending might result in a slightly less red lipstick than in the model's output. Other blending operations are also possible and contemplated within the scope of the illustrative embodiments.

Some embodiments offer a user an opportunity to view and approve or reject a modified 2D image before (if approved) adding the adjusted 2D image to the set of 2D images. If the user rejects the modified image, one embodiment offers a user an opportunity to adjust the adjustment instruction and repeats the image modification until the user is satisfied with the resulting image. Another embodiment generates a more extreme version of the modified image than instructed by the adjustment instruction and offers a user an opportunity to interpolate between the original and extreme images until the user is satisfied with the resulting image. One embodiment implements a slider user interface element for the user to perform the interpolation.

Using a three-dimensional modelling model, an embodiment generates a three-dimensional model from the input set of two-dimensional images including one or more modified images. The three-dimensional modelling model iteratively generates a coherent representation that is temporally and spatially consistent, even if individual modified images are not consistent with each other. For example, the three-dimensional modelling model removes color inconsistencies and location shifts from one individually modified 2D image to another. In one embodiment, the three-dimensional modelling model is Pixel Codec Avatars, a generative model of 3D human faces that is presently available. Other three-dimensional modelling models are also possible and contemplated within the scope of the illustrative embodiments.

Some embodiments offer a user an opportunity to view and approve or reject the 3D model. If the user rejects the 3D model, one embodiment offers a user an opportunity to adjust the adjustment instruction and repeats the image modification and 3D modelling in real time until the user is satisfied with the resulting model. Another embodiment generates two correlated models, one using the original set of input images and one a more extreme version of the 3D model than instructed by the adjustment instruction. The embodiment offers a user an opportunity to interpolate between the two models until the user is satisfied with the resulting image. One embodiment implements a slider user interface element for the user to perform the interpolation. One embodiment offers a user an opportunity to interpolate between correlated models in real-time. Another embodiment generates multiple 3D models, implementing different adjustments (from predefined or user-supplied augmentation instructions), and offers a user an opportunity to select a model as desired.

An embodiment renders the 3D model for display in a two-dimensional format. Another embodiment renders the 3D model for display in an MR environment.

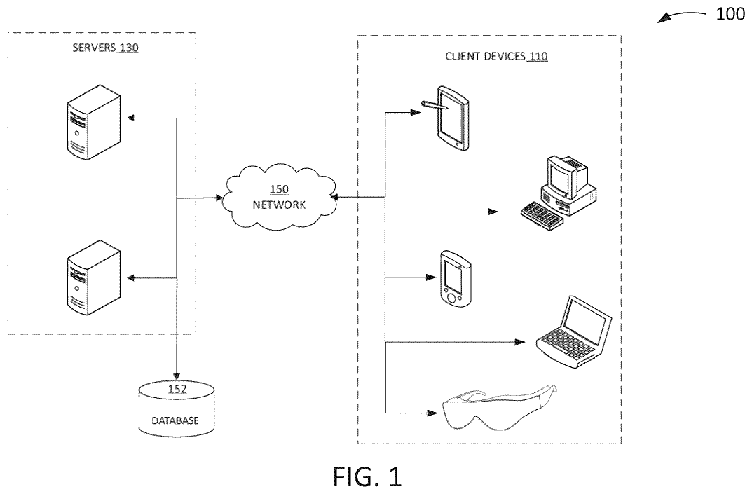

FIG. 1 illustrates a network architecture 100 used to implement personalized avatar adjustment using text prompted image generation, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

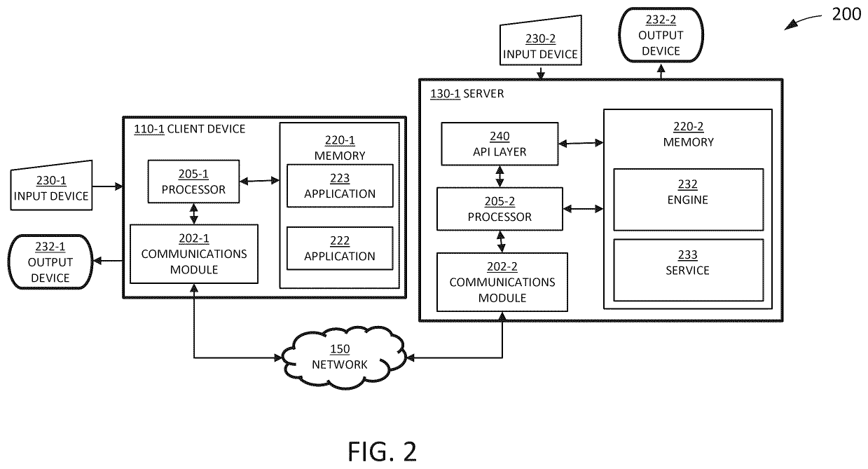

FIG. 2 is a block diagram illustrating details of a system 200 for personalized avatar adjustment using text prompted image generation, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement personalized avatar adjustment using text prompted image generation. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide personalized avatar adjustment using text prompted image generation. The application 223 may communicate with service 233 through API layer 240, for example.

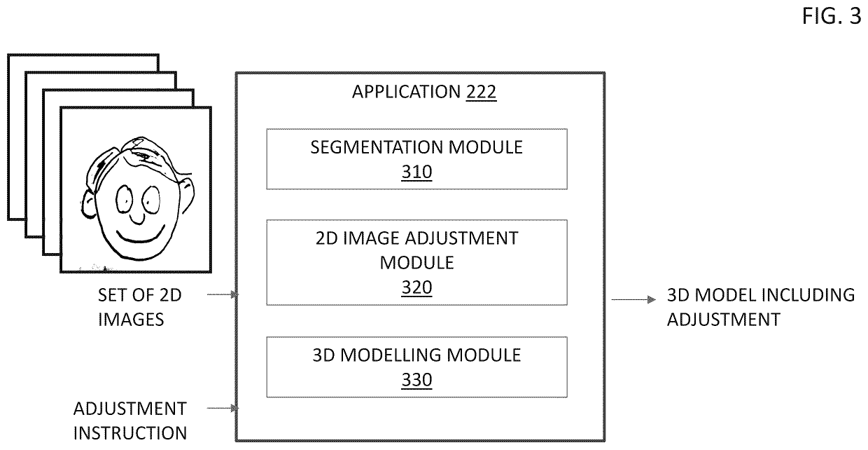

FIG. 3 depicts a block diagram of an example configuration for personalized avatar adjustment using text prompted image generation, in accordance with an illustrative embodiment. Application 222 is the same as application 222 in FIG. 2.

Application 222 receives, as input, a set of 2D images. Images in the set of 2D images depict a user's face, for adjustment and generation of a 3D model of the user's face. Two non-limiting examples of a set of 2D images are a series of images of individual poses of the user's face (e.g., with varying facial expressions or head positions) or individual frames of a portion of video. Application 222 also receives, as input, an adjustment instruction. In some implementations of application 222, the adjustment instruction is in text form. The adjustment instruction need not be in structured text form. Some non-limiting examples of an adjustment instruction are “add red lipstick”, “add eyeliner”, “add smoky eyeshadow”, “add light makeup”, “add night-out makeup”, “add business professional makeup”, “remove mole”, “smooth skin”, “lighten hair color one shade”, “darken hair color one shade”, “add some grey at temples”, “retouch grey hair roots”, an instruction to provide makeup inspired by a well-known actor or singer, “simplify this image”, “make this image more realistic”, and the like. In some implementations of application 222, the adjustment instruction is in the form of an image, such as a reference or target image. In some implementations of application 222, the adjustment instruction is a combination of an image and text, for example “make me look like this image”.

Segmentation module 310 uses a presently available technique to recognize one or more facial features in a 2D image in the set of 2D images. Some non-limiting examples of a facial feature are lips, nose, eyebrows, eyes and mouth. Module 310 generates a segmentation mask corresponding to the image. The segmentation mask identifies a changeable portion and a non-changeable portion of the image. As modifying the size, shape, and geometrical relationships between areas such as the eyes and mouth can alter presentation of a user's identity too much to be perceived as still portraying the same user, some implementations of module 310 include one or more facial features, such as lip, nose, eyebrow, eye, and mouth portions of the 2D image, within one or more non-changeable portions of the segmentation mask. Other areas of a user's face, such as cheeks, forehead, and hair, are typically less important in portraying a user's identity, and thus module 310 adds these areas to a changeable portion of the segmentation mask. Some implementations of module 310 provide a suer an ability to specify (e.g., in a user profile or in an adjustment instruction) which facial features, if any, are designated as non-changeable. In other embodiments, the non-changeable facial features are predetermined.

Application 222 generates a numerical representation of the 2D image and a numerical representation of the image's corresponding segmentation mask. A numerical, optionally compressed, representation of an input image is usable to reconstruct the image. Modifying a numerical representation of an input image modifies the reconstructed image accordingly. One non-limiting example of a numerical representation is a latent vector representing an image within a latent diffusion model. Each numerical representation is in the same size and format. Two non-limiting examples of a numerical representation format are a 64×64 matrix of floating-point numbers (or a matrix rearranged into a one-dimensional vector) for a 512×512 input image and a 64×64 tensor of N values per point (thus, dimensions of 64×64×N). Generating numerical representations preserves spatial meaning of the source images, and thus a numerical representation of the segmentation mask is usable to delineate changeable and non-changeable portions of the numerical representation of the 2D image. Techniques are presently available to generate numerical representations of both the 2D image and the segmentation mask.

Application 222 generates a positive prompt and a negative prompt from an input adjustment instruction. A positive prompt instructs an image modification model to adjust an image towards a goal, and a negative prompt instructs an image modification model to adjust an image away from the same goal or towards an opposite goal. For example, for an adjustment instruction of “add eyeliner”, corresponding positive and negative prompts might be “add eyeliner” and “remove eyeliner” respectively. As another example, for an adjustment instruction of “smooth skin”, corresponding positive and negative prompts might be “smooth skin” and “blemished skin” respectively. If an adjustment instruction includes an image, application 222 uses a presently available technique to generate a text description of the image and includes the generated text description into a positive prompt, negative prompt, or both. To generate a positive prompt and a negative prompt from an input adjustment instruction, application 222 uses a presently available technique, such as using a trained natural language processing model, a trained large language model (LLM), or a set of rules or heuristics.

From a numerical representation of the input two-dimensional image, a numerical representation of a segmentation mask corresponding to the input 2D image, a positive prompt, and a negative prompt, 2D image adjustment module 320 uses an image modification model to adjust the input two-dimensional image. The adjusting results in a second two-dimensional image. Module 320 replaces the input 2D image with the second two-dimensional image in the set of two-dimensional images. In one implementation of module 320, the image modification model is a pre-trained diffusion model such as a delta denoising score (DDS) optimization model, a presently available technique. The DDS model has been trained to modify a numerical representation of an input image, masked by the numerical representation of the segmentation mask, to be more like the positive prompt than the negative prompt. The image modification model operates on a per-image or per-frame basis, without enforcing consistency among modified images in the set of input 2D images. The amount of image adjustment is controllable by adjusting the model's control parameters, such as the number of optimization iterations the model is to perform or a completion criterion for the model's adjustments. Other image modification models, using either positive and negative prompts or a single adjustment instruction, are also possible.

One implementation of module 320 performs a blending operation on numerical representations of the input two-dimensional image and the adjusted two-dimensional image. If O denotes a set of parameters of the original two-dimensional image and M denotes a corresponding set of parameters of the adjusted, or modified, two-dimensional image, one embodiment computes a blended representation B=alpha*O+(1-alpha)*M, where alpha denotes a constant. Blending allows application 222 to combine the two images, thus moderating output of the image adjustment model. For example, if the adjustment instruction was to add red lipstick, blending might result in a slightly less red lipstick than in the model's output. Other blending operations are also possible.

Some implementations of module 320 offer a user an opportunity to view and approve or reject a modified 2D image before (if approved) adding the adjusted 2D image to the set of 2D images. If the user rejects the modified image, one implementation of module 320 offers a user an opportunity to adjust the adjustment instruction and repeats the image modification until the user is satisfied with the resulting image. Another implementation of module 320 generates a more extreme version of the modified image than instructed by the adjustment instruction and offers a user an opportunity to interpolate between the original and extreme images until the user is satisfied with the resulting image. One implementation of module 320 implements a slider user interface element for the user to perform the interpolation.

Using a three-dimensional modelling model, 3D modelling module 330 generates a three-dimensional model from the input set of two-dimensional images including one or more modified images. The three-dimensional modelling model iteratively generates a coherent representation that is temporally and spatially consistent, even if individual modified images are not consistent with each other. For example, the three-dimensional modelling model removes color inconsistencies and location shifts from one individually modified 2D image to another. In one implementation of module 330, the three-dimensional modelling model is Pixel Codec Avatars, a generative model of 3D human faces that is presently available. Other three-dimensional modelling models are also possible.

Some implementations of module 330 offer a user an opportunity to view and approve or reject the 3D model. If the user rejects the 3D model, one implementation of module 330 offers a user an opportunity to adjust the adjustment instruction and repeats the image modification and 3D modelling in real time until the user is satisfied with the resulting model. Another implementation of module 330 generates two correlated models, one using the original set of input images and one a more extreme version of the 3D model than instructed by the adjustment instruction. The implementation offers a user an opportunity to interpolate between the two models until the user is satisfied with the resulting image. One implementation of module 330 implements a slider user interface element for the user to perform the interpolation. One implementation of module 330 offers a user an opportunity to interpolate between correlated models in real-time. Another implementation of module 330 generates multiple 3D models, implementing different adjustments (from predefined or user-supplied augmentation instructions), and offers a user an opportunity to select a model as desired.

Module 330 renders the 3D model for display in a two-dimensional format or for display in an MR environment.

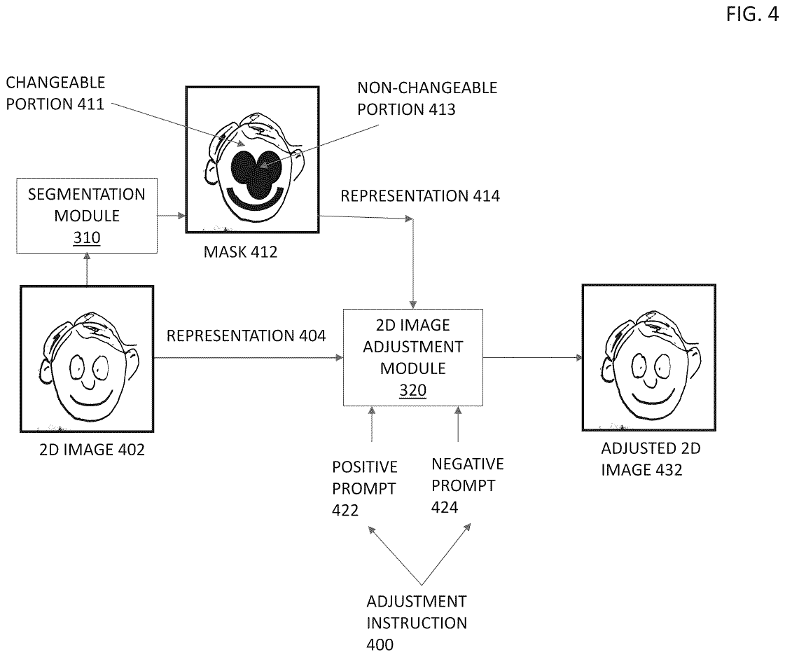

FIG. 4 depicts an example of personalized avatar adjustment using text prompted image generation, in accordance with an illustrative embodiment. Segmentation module 310 and 2D image adjustment module 320 are the same as segmentation module 310 and 2D image adjustment module 320 in FIG. 3. The example can be executed using application 222 in FIG. 2.

Segmentation module 310 uses a presently available technique to recognize one or more facial features in 2D image 402, one of a set of input 2D images. Some non-limiting examples of a facial feature are lips, nose, eyebrows, eyes and mouth. Module 310 generates mask 412, a segmentation mask corresponding to 2D image 402. The segmentation mask identifies changeable portion 411 and non-changeable portion 413 of the image. As modifying the size, shape, and geometrical relationships between areas such as the eyes and mouth can alter presentation of a user's identity too much to be perceived as still portraying the same user, mask 412 includes one or more facial features, such as lip, nose, eyebrow, eye, and mouth portions of 2D image 402, within one or more non-changeable portions (e.g., non-changeable portion 413) of mask 412.

Representation 404 is a numerical representation of 2D image 402. Representation 414 is a numerical representation of mask 412. Each numerical representation is in the same size and format, for example a 64×64 matrix of floating-point numbers (or a matrix rearranged into a one-dimensional vector) for a 512×512 input image. Application 222 generates positive prompt 422 and negative prompt 424 from input adjustment instruction 400.

From representation 404, representation 414, positive prompt 422, and negative prompt 424, 2D image adjustment module 320 uses an image modification model to adjust 2D image 402. The adjusting results in adjusted 2D image 432. Module 320 replaces 2D image 402 with adjusted 2D image 432 in the set of two-dimensional images.

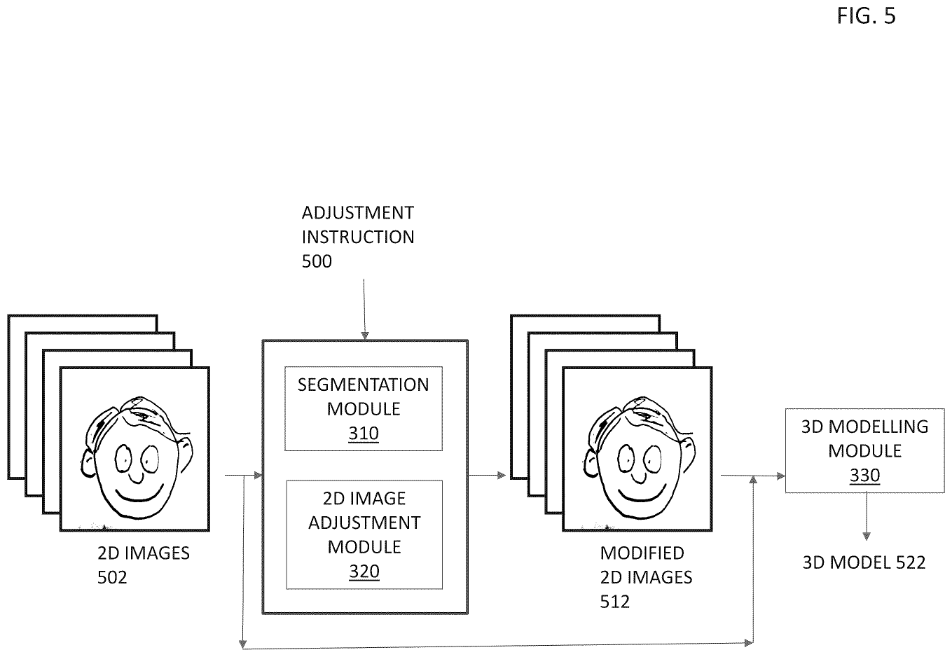

FIG. 5 depicts a continued example of personalized avatar adjustment using text prompted image generation, in accordance with an illustrative embodiment. Segmentation module 310, 2D image adjustment module 320, and 3D modelling module 330 are the same as segmentation module 310, 2D image adjustment module 320, and 3D modelling module 330 in FIG. 3.

Segmentation module 310 and 2D image adjustment module 320 adjust one or more images within 2D images 502 in accordance with adjustment instruction 500, generating modified 2D images 512. 3D modelling module 330 generates 3D model 522 from one or more of modified 2D images 512 and 2D images 502.

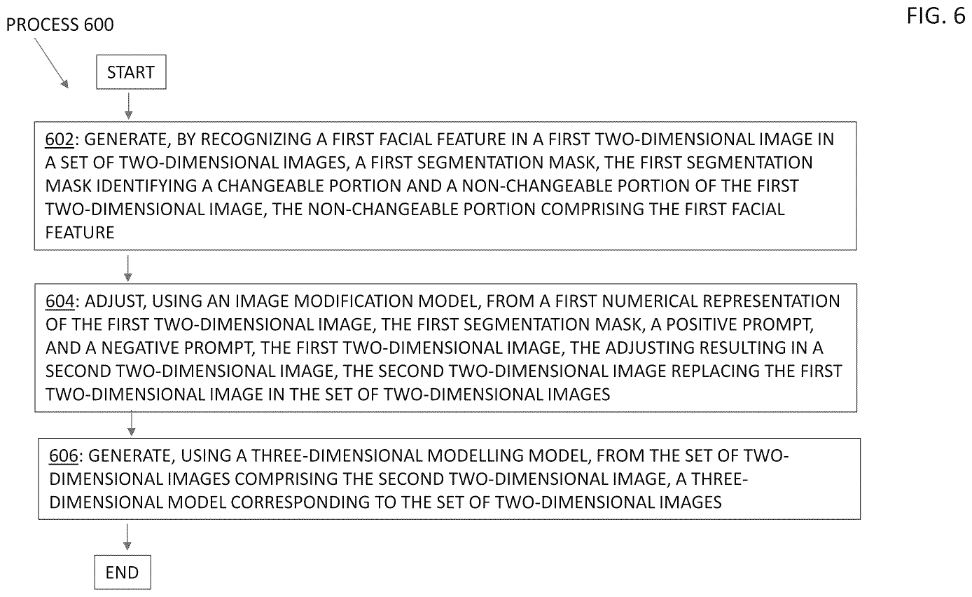

FIG. 6 depicts a flowchart of an example process for personalized avatar adjustment using text prompted image generation, in accordance with an illustrative embodiment. Process 600 can be implemented in application 222 in FIG. 2.

At block 602, the process generates, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature. At block 604, the process adjusts, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images. At block 606, the process generates, using a three-dimensional modelling model, from the set of two-dimensional images comprising the second two-dimensional image, a three-dimensional model corresponding to the set of two-dimensional images. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims or clauses are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A computer-implemented method comprising:
generating, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature;
adjusting, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and
generating, using a three-dimensional modelling model, from the set of two-dimensional images comprising the second two-dimensional image, a three-dimensional model corresponding to the set of two-dimensional images.

2. The computer-implemented method of claim 1, wherein each image in the set of two-dimensional images depicts a face of a user.

3. The computer-implemented method of claim 1, wherein the set of two-dimensional images comprises individual frames of a portion of video.

4. The computer-implemented method of claim 1, further comprising:
generating, from an adjustment instruction, the positive prompt and the negative prompt.

5. The computer-implemented method of claim 1, further comprising:
generating, by interpolating between the three-dimensional model and a second three-dimensional model, a third three-dimensional model, wherein the second three-dimensional model is generated from the set of two-dimensional images comprising the first two-dimensional image instead of the second two-dimensional image.

6. The computer-implemented method of claim 1, further comprising:
rendering, for display in a two-dimensional format, the three-dimensional model.

7. The computer-implemented method of claim 1, further comprising:
rendering, for display in a mixed reality environment, the three-dimensional model.

8. A non-transitory computer-readable medium storing a program, which when executed by a computer, configures the computer to:
generate, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature;
adjust, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and
generate, using a three-dimensional modelling model, from the set of two-dimensional images comprising the second two-dimensional image, a three-dimensional model corresponding to the set of two-dimensional images.

9. The non-transitory computer-readable medium of claim 8, wherein each image in the set of two-dimensional images depicts a face of a user.

10. The non-transitory computer-readable medium of claim 8, wherein the set of two-dimensional images comprises individual frames of a portion of video.

11. The non-transitory computer-readable medium of claim 8, wherein the program, when executed by the computer, further configures the computer to:
generate, from an adjustment instruction, the positive prompt and the negative prompt.

12. The non-transitory computer-readable medium of claim 8, wherein the program, when executed by the computer, further configures the computer to:
generate, by interpolating between the three-dimensional model and a second three-dimensional model, a third three-dimensional model, wherein the second three-dimensional model is generated from the set of two-dimensional images comprising the first two-dimensional image instead of the second two-dimensional image.

13. The non-transitory computer-readable medium of claim 8, wherein the program, when executed by the computer, further configures the computer to:
render, for display in a two-dimensional format, the three-dimensional model.

14. The non-transitory computer-readable medium of claim 8, wherein the program, when executed by the computer, further configures the computer to:
render, for display in a mixed reality environment, the three-dimensional model.

15. A system comprising:
a processor; and
a non-transitory computer readable medium storing a set of instructions, which when executed by the processor, configure the system to:
generate, by recognizing a first facial feature in a first two-dimensional image in a set of two-dimensional images, a first segmentation mask, the first segmentation mask identifying a changeable portion and a non-changeable portion of the first two-dimensional image, the non-changeable portion comprising the first facial feature;
adjust, using an image modification model, from a first numerical representation of the first two-dimensional image, the first segmentation mask, a positive prompt, and a negative prompt, the first two-dimensional image, the adjusting resulting in a second two-dimensional image, the second two-dimensional image replacing the first two-dimensional image in the set of two-dimensional images; and
generate, using a three-dimensional modelling model, from the set of two-dimensional images comprising the second two-dimensional image, a three-dimensional model corresponding to the set of two-dimensional images.

16. The system of claim 15, wherein each image in the set of two-dimensional images depicts a face of a user.

17. The system of claim 15, wherein the set of two-dimensional images comprises individual frames of a portion of video.

18. The system of claim 15, wherein the instructions, when executed by the processor, further configure the system to:
generate, from an adjustment instruction, the positive prompt and the negative prompt.

19. The system of claim 15, wherein the instructions, when executed by the processor, further configure the system to:
generate, by interpolating between the three-dimensional model and a second three-dimensional model, a third three-dimensional model, wherein the second three-dimensional model is generated from the set of two-dimensional images comprising the first two-dimensional image instead of the second two-dimensional image.

20. The system of claim 15, wherein the instructions, when executed by the processor, further configure the system to:
render, for display in a two-dimensional format, the three-dimensional model.
